(19) United States
(12) Patent Application Publication
(10) Pub. No.: US 2026/0266306 A1
(43) Pub. Date: Sep. 10, 2026

(54) COMPRESSOR DRY GAS SEAL EMISSIONS

(71) Applicant: AES ENGINEERING Ltd., Rotherham (GB)

(72) Inventors: Christopher Carmody, Rotherham (GB); Christooher Rea, Rotherham (GB)

(73) Assignee: AES ENGINEERING Ltd., Rotherham (GB)

(21) Appl. No.: 19/729,033

(22) Filed: Feb. 11, 2026

(30) Foreign Application Priority Data
Feb. 11, 2025 (GB) 2502029.8
Jul. 16, 2025 (GB) 2511513.0

(51) Int. Cl. F04D 29/08; F04D 17/10; F16J 15/00

(52) U.S. Cl. CPC F04D 29/083; F04D 17/10; F16J 15/006

(57) ABSTRACT

A gas recycling system for use with a gas compressor having an inlet for gas at a relatively low pressure and an outlet for gas at a relatively high pressure, a gas-lubricated, non-contacting, double mechanical seal to which relatively high pressure gas may be fed from the compressor, the gas recycling system including a seal gas booster for boosting the pressure of the gas between the compressor and the double mechanical seal.

### BACKGROUND OF THE INVENTION

### Technical Field of the Invention

The present invention relates to centrifugal compressors and other similar rotating equipment and, more particularly, to systems for controlling the emissions of gases from dry gas seals used with such equipment.

### Description of the Prior Art

Centrifugal compressors and other similar rotating equipment are used to transport gases from one place to another or through process systems containing gases. These devices utilize rotating shafts containing impeller devices (or similar) which impart energy into the gas due to rotary motion. As a result, gas flow and pressure are raised. In order to sustain the pressure the rotor has to be housed in a pressurized casing where some sort of sealing device is required at the point of entry/exit where the rotary shaft passes through the casing.

A consequence of the speed and pressure that the rotor and hence seals are subject to is that, normally, a fluid is necessary in order to lubricate the interface between rotating and stationary components within the seal arrangement. In situations where dry seals (DGS) are used for sealing purposes, gas is used as the primary means of lubrication. In common with all forms of lubrication, there is a requirement that lubrication fluid is conditioned to be clean. However, in the case of a DGS, the lubrication gas must also be kept dry at all times. The necessity for clean and conditioned gas is largely because the lubrication film supports the entire sealing loads even though this film is only a few microns thick. In situations where the lubrication gas film becomes contaminated, the operation and reliability of the DGS is compromised. The contaminated gas may also adversely affect other seal components dictating that clean and dry gas is an essential element in preventing failure of DGS's.

Compressor DGS double seals have two sets of faces which are usually lubricated with nitrogen introduced into a cavity between the two sets of faces at a higher pressure than the process gas contained within the process side seal cavity. This arrangement dictates that no process gas can flow through the seals and into the vent system, dictating that double seals normally operate with zero process gas emissions being released to atmosphere since the only exhaust gas from the seal is inert nitrogen. Despite the significant benefits of zero process gas emissions, double seals have always been limited to very low duty (speed and pressure) compressor applications due to problems associated with seal components overheating and subsequently failing due to the increase in gas temperature within the confines of the seal assembly.

A further requirement to ensure reliable DGS operation is that the gas on the process side of the seal is properly conditioned so that seal contamination is avoided. This is most readily achieved by introducing a gas flow within the process side seal cavity and back into the compressor such that the unconditioned process gas contained within the compressor casing cannot enter the sealing cavity. A forward flow of conditioned seal gas from the process side seal cavity into the compressor casing through a restriction device prevents a flow reversal whereby unconditioned process gas can flow from the compressor casing into the process side seal cavity. When the compressor is in operation, gas is tapped off from a high pressure region of the compressor forcing it to flow through a conditioning system where it is cleaned and dried before entering into the process side seal cavity. Given that the gas flowing past the seals in the seal cavity is clean and dry and directed towards the main compressor casing there is no contamination which can cause the seal to fail prematurely. Once inside this seal cavity the gas flows back into the compressor through a restrictive device which ensures that unconditioned gas contained downstream within the compressor cannot enter the seal cavity, thus ensuring that there is no DGS contamination.

However, when the compressor is taken offline, the shaft rotation ceases thus disabling its pressure generating ability. The lack of pressure also dictates that gas no longer flows through the conditioning system, and therefore clean and dry gas no longer flows into the process seal cavity. A further consequence of the lack of conditioned gas flowing through the process seal cavity is that unconditioned process gas reverse flows from the compressor through the restrictive device and into the process seal cavity so contaminated gas is present in the seal cavity. A further issue relating to the compressor being taken offline is that the compressor and contents begin to cool due to energy no longer being imparted into the process gas. As the gas cools it becomes increasingly wet as it nears vapor conditions where again it has an adverse effect on the seal gas. In the absence of having a means of preventing gas contamination when a compressor is offline, most operators elect to allow the gas to discharge from the compressor thus discharging its contents to atmosphere either directly or via a flare arrangement. This process is commonly referred to as a blowdown, an event which produces large amounts of damaging gas being released to atmosphere over a short period of time.

The associated issues are twofold:
1) Double DGS seals are restricted to lesser duties thus limiting their potential to be used as replacements for other DGS arrangements; and,
2) Evacuating process gas (blowdown) when the compressor is offline.

Gas boosters are known for use with tandem dry gas seals. Examples are disclosed in P.C.T. Application Publication No. WO2022/117227; P.C.T. Application Publication No. WO2024/088558; P.C.T. Application Publication No. WO2024/104608; European Patent Application No. EP 1,128,101; and P.C.T. Application Publication No. WO 2010/056408. However, tandem and double dry gas seals are functionally quite different. The seal gas supply for a tandem seal is to the process side of the seal and is conditioned process gas. The seal gas supply for a double seal is between the two sets of seal faces and is inert nitrogen gas. Accordingly, the use of a gas booster in a tandem seal is to one side of the seal only and will not be effective in a double seal where it is necessary to deal with both sides of the seal during seal stand stills and start up.

### SUMMARY OF THE INVENTION

According to the present invention, there is provided a gas recycling system for use with a gas compressor having an inlet for gas at a relatively low pressure and an outlet for gas at a relatively high pressure, a gas-lubricated, non-contacting double mechanical seal to which

relatively high pressure gas may be fed from the compressor, the system comprising a seal gas booster for boosting the pressure of the gas between the compressor and the double mechanical seal.

The present invention allows the arrangement to be utilized for moderate and high operating conditions.

The prevention of compressor DGS gas seal emissions can most easily be achieved by installing double seal arrangements where the only seal leakage is inert nitrogen that poses no environmental issues. The issue is that the seals are prone to overheating when subject to moderate or high speeds and/or pressure.

Blowdown prevention can be prevented by introducing a booster device in the seal gas supply system such that flow is generated when the compressor is offline so that conditioned gas is supplied to the process side seal cavity at all times. The supply of conditioned gas dictates that there will be no contamination of the DGS's. Atmospheric emissions during blowdowns are therefore prevented.

In the combined system of the present invention, the double seal is continuously cooled during normal operation and as a seal gas booster when the compressor is offline.

Preferably, the system comprises means for feeding seal gas from the compressor to a conditioning system and from said conditioning system to said mechanical seal.

Preferably, means are provided to cause the booster, while the compressor is not operating, to feed the seal gas through the conditioning system.

Preferably, the system includes a cooler for the inert gas. The cooler may be integral with the booster or be a device which is separate to the booster.

Preferably, means are provided to monitor the pressure difference between the compressor inlet and outlet and for activating the gas booster when the pressure difference falls below a predetermined level.

Preferably, means are provided to activate the gas booster when the pressure difference exceeds a predetermined level.

The present invention also provides a method for recycling gas leaking from a gas-lubricated, non-contacting mechanical seal, the method comprising subjecting the leaked gas to the action of a gas recycling system of the invention.

Other objects and features of the present invention will become apparent when considered in combination with the accompanying drawing figures, which illustrate certain preferred embodiments of the present invention. It should, however, be noted that the accompanying drawing figures are intended to illustrate only select preferred embodiments of the claimed invention and are not intended as a means for defining the limits and scope of the invention.

### BRIEF DESCRIPTION OF THE DRAWING FIGURES

The accompanying drawing figures will illustrate preferred embodiments of the present invention and are as follows:

FIG. 1 is a diagram of a compressor system of the invention shown in normal operation;

FIG. 2 shows the compressor system of FIG. 1 in offline operation; and,

FIG. 3 shows the compressor system of FIG. 1 in start-up mode.

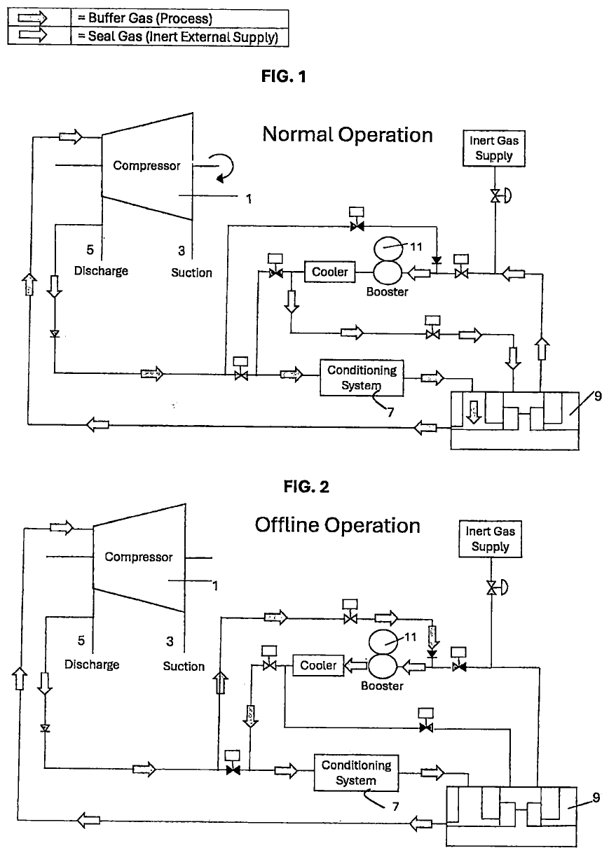

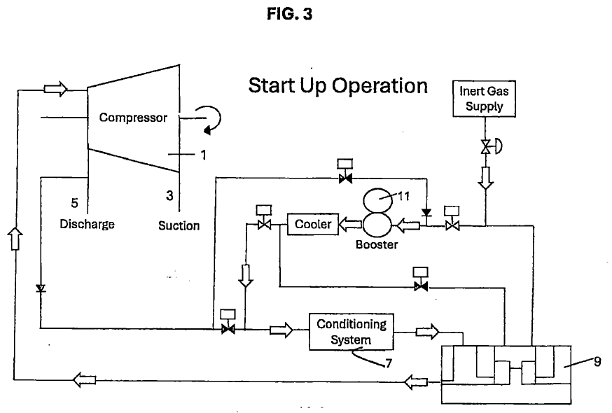

### DETAILED DESCRIPTION OF THE DRAWING FIGURES AND PREFERRED EMBODIMENTS

Normal Operation—Referring to FIG. 1 of the accompanying drawings, process gas pressure is increased as it passes through the compressor 1 from the compressor inlet 3 (suction) to discharge outlet 5. At the high pressure discharge end 5 of the compressor some gas is taken and routed through a conditioning system 7 which is used to produce clean and dry gas to double DGS's 9 fitted to the compressor 1. The gas has to be conditioned so that the double DGS 9 does not get contaminated and subsequent failure occurs. Since the compressor 1 is operational there is sufficient seal gas pressure for it to flow through the conditioning system without the need for a booster. Accordingly, during normal operation the seal gas circuit valves are closed and gas flows through a booster bypass line and not through the booster 11. The double seal gas circuit inlet and outlet valves are open during normal operation allowing inert gas to flow around the circuit. Inert gas is supplied to this circuit such that the pressure is maintained at a predetermined value which is slightly higher than the pressure in the process side seal cavity. The latter is normally achieved using a pressure regulating valve, or similar device. Accordingly, while the compressor is in normal operation the inert gas supplied to the double seals is circulated and cooled around its own circuit such that the double seal cannot overheat.

Offline Operation—During offline operation, the compressor 1 does not generate pressure and therefore gas cannot flow through the conditioning system 7. This necessitates the need for a booster 11 to provide sufficient flow of seal gas through the conditioning system. During offline operation the booster seal gas circuit inlet and outlet valves are open and the corresponding double seal circuit inlet and outlet valves are closed. However, since the inert gas supply is still connected to the double seal circuit, pressure is still maintained. The cooler can be either a separate device or an integral part of the booster.

Start Up Operation—As the start-up sequence commences, the booster circuit inlet valve is closed and the cooling circuit booster inlet valve is opened allowing clean inert gas to enter the combined system. This purges the process gas from the seal gas circuit back into the compressor 1. Once the process gas is expelled from the circuit, the seal gas booster circuit outlet valve is closed and the double seal cooling circuit inlet valve is opened and normal operation is attained.

The pressure difference between the compressor suction 3 and discharge 5 is monitored. In general terms, the pressure difference (or head generated) increases with speed and duration of operation. When the pressure difference falls to around 0.5 bar, the compressor is considered to be offline. At this point a signal will be sent which starts the seal gas booster 11 and, once the compressor is back in service (i.e., the pressure difference goes above 0.5 bar), a further signal is produced which will stop the seal gas booster.

The process side seal cavity pressure is normally monitored by a pressure transmitter. A signal is sent to allow the inert gas supply pressure to increase to a predetermined pressure which is higher than the process side seal cavity pressure. When the pressure reduces to a predetermined pressure the signal is sent to allow a control valve to open. Similarly, if the pressure in the double seal cooling circuit increases above a predetermined level, then pressure is relieved.

While only several embodiments of the present invention have been shown and described, it will be obvious to those skilled in the art that many modifications may be made to the present invention without departing from the spirit and scope thereof.

What is claimed is:

1. A gas recycling system for use with a gas compressor having an inlet for gas at a low pressure and an outlet for gas at a high pressure, a gas-lubricated, non-contacting, double mechanical seal to which a high pressure gas is able to be fed from the gas compressor, said gas recycling system comprising a seal gas booster for boosting pressure of a gas between the gas compressor and the double mechanical seal.

2. The gas recycling system according to claim 1, wherein said gas recycling system further comprises means for feeding seal gas from the gas compressor to a conditioning system and from said conditioning system to said double mechanical seal.

3. The gas recycling system according to claim 2, further comprising means for causing said seal gas booster, while the gas compressor is not operating, to feed the gas through said conditioning system.

4. The gas recycling system according to according to claim 1, further comprising a cooler for the gas.

5. The gas recycling system according to according to claim 4, wherein the gas is an inert gas.

6. The gas recycling system according to claim 4, wherein said cooler is integral with said seal gas booster.

7. The gas recycling system according to claim 4, wherein said cooler is separate from, and not integral with, said seal gas booster.

8. The gas recycling system according to claim 1, further comprising means for monitoring a pressure difference between the gas compressor inlet and outlet and for activating said seal gas booster when the pressure difference falls below a predetermined level.

9. The gas recycling system according to Clam 8, further comprising means for activating said seal gas booster when the pressure difference exceeds a predetermined level.

10. The gas recycling system according to claim 1, further comprising means for monitoring a pressure difference between the gas compressor inlet and outlet and for activating said seal gas booster when the pressure difference exceeds a predetermined level.

11. A method for recycling gas leaking from a gas-lubricated, non-contacting mechanical seal, comprising the step of subjecting the gas leaking to a gas recycling system for use with a compressor having an inlet for gas at a low pressure and an outlet for gas at a high pressure, a gas-lubricated, non-contacting, double mechanical seal to which a high pressure gas is able to be fed from the gas compressor, said gas recycling system comprising a seal gas booster for boosting pressure of a gas between the gas compressor and the double mechanical seal.

12. The method for recycling gas leaking from a gas-lubricated, non-contacting mechanical seal according to claim 11, wherein said gas recycling system further comprises means for feeding seal gas from the gas compressor to a conditioning system and from said conditioning system to said double mechanical seal.

13. The method for recycling gas leaking from a gas-lubricated, non-contacting mechanical seal according to claim 11, wherein said gas recycling system further comprises a cooler for the gas.

14. The method for recycling gas leaking from a gas-lubricated, non-contacting mechanical seal according to claim 11, wherein said gas recycling system further comprises means for monitoring a pressure difference between the gas compressor inlet and outlet and for activating said seal gas booster when the pressure difference falls below a predetermined level.

15. The method for recycling gas leaking from a gas-lubricated, non-contacting mechanical seal according to claim 11, wherein said gas recycling system further comprises means for monitoring a pressure difference between the gas compressor inlet and outlet and for activating said seal gas booster when the pressure difference exceeds a predetermined level.
